(19) United States
(12) Patent Application Publication
(10) Pub. No.: US 2025/0018787 A1
(43) Pub. Date: Jan. 16, 2025

(54) Driving Assembly and Vehicle

(71) Applicant: Illinois Tool Works Inc., Glenview, IL (US)

(72) Inventors: Gang YU, Shanghai (CN); Wenquan SHA, Shanghai (CN); Yuan SUN, Shanghai (CN); Bin CHEN, Shanghai (CN)

(21) Appl. No.: 18/752,687

(22) Filed: Jun. 24, 2024

(30) Foreign Application Priority Data
Jul. 14, 2023 (CN) 202310870287.2

(51) Int. Cl. B60K 15/05; E05B 81/20

(52) U.S. Cl. CPC B60K 15/05; E05B 81/20; B60K 2015/0515

(57) ABSTRACT

The present disclosure relates to a driving assembly having a fixed gear, a fixed rack, a movable intermediate rack, a movable gear, and a transmission rack. The movable intermediate rack cooperates with the fixed gear such that the movable intermediate rack is capable of being driven to reciprocate when the fixed gear rotates clockwise and counterclockwise; the movable rotary shaft is rotatably fixed to the movable intermediate rack, and the movable gear cooperates with the fixed rack such that the movable gear is capable of reciprocatingly translating along an extension direction of the fixed rack when the movable intermediate rack reciprocates, and the movable gear is capable of rotating about the movable rotary shaft; and the transmission rack is capable of driving a member to be driven. The transmission rack cooperates with the movable gear such that the transmission rack is capable of being driven to reciprocate so as to move the member to be driven when the movable gear rotates clockwise and counterclockwise. In the driving assembly of the present disclosure, the combination of gears and racks enables the transmission rack to have a smaller size and move at a faster speed for the same movement distance.

### RELATED APPLICATION

The present application claims the benefit of Chinese Patent Application No. 202310870287.2, filed Jul. 14, 2023, titled “Driving Assembly and Vehicle,” the contents of which are hereby incorporated by reference.

### TECHNICAL FIELD

The present disclosure relates to a driving assembly and a vehicle, and in particular to a driving assembly for driving a lid of a fuel tank, a charging port, a door handle or a loading recess region of a vehicle, and a vehicle using the driving assembly.

### BACKGROUND

A lid assembly of an object includes a housing, a lid, and a driving assembly connected to the lid to drive the lid to open or close. The driving device has a gear and rack structure, in which the gear is coaxially connected to an actuator, an output shaft of the actuator rotates to drive the gear to rotate and in turn drive a rack meshing with a gear to move linearly, and the rack is connected to the lid, so that the linear movement of the rack can drive the lid to open and close.

In the prior art, in order to move a lid of a lid assembly from a closed position to an open position, a rack of a driving assembly needs to move a certain distance, so that the length of a toothed portion of the rack should not be less than the displacement length of the rack (i.e., the longest translation distance of the rack is the length of the toothed portion). When the lid is moved from the closed position to the open position, the rack's translation may cause the rack to extend out of the lid assembly, thus causing a risk of interference with other ambient components of a vehicle body.

In addition, in the prior art, an actuator that drives a gear has a constant input voltage, so that the rotational speed of the actuator is limited by the magnitude of the input voltage, resulting in a slower rotational speed of the gear and in turn a slower movement speed of the rack, finally resulting in a slower lid opening or closing speed of the lid assembly. In the case of achieving faster opening or closing speed of the lid by means of increasing the diameter of the gear, more space inside the lid assembly will be occupied disadvantageously.

It is desired to provide a driving assembly, which is provided with a rack having a relative smaller length, such that the rack can not only allow the lid to move from the closed position to the open position, but also minimize the length of portion of the rack extending out of the lid assembly during the movement.

It is desired to provide a driving assembly, which solves the problem of slow opening or closing of the lid without increasing the overall size of the lid assembly.

### SUMMARY

The present disclosure relates generally to a driving assembly, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1A is a perspective view of a driving assembly for driving a lid assembly in a lid-closed state.

FIG. 1B is a perspective view of the driving assembly for driving the lid assembly in a lid-open state.

FIG. 1C is a perspective view of the lid assembly shown in FIG. 1A, with an upper housing cover being hidden.

FIG. 1D is a perspective view of the housing shown in FIG. 1B, with the upper housing cover being hidden.

FIG. 2A is a side view of the lid assembly shown in FIG. 1A, in which the lid is in the closed position.

FIG. 2B is a side view of the lid assembly shown in FIG. 1B, in which the lid is in the open position.

FIG. 2C is a schematic diagram illustrating force analysis of the driving assembly of the present disclosure.

FIG. 3A is a perspective view of another example of a driving assembly in a lid-closed state.

FIG. 3B is a perspective view of another example of the driving assembly in a lid-open state.

FIG. 4 is a schematic diagram of a vehicle provided with the lid assembly and the driving assembly of the present disclosure.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

A lid assembly of the present disclosure can be applied in various scenarios, for example, any one of a refueling port of a fuel vehicle, a charging port of an electric vehicle, a door handle of a vehicle, a liquid filling port of a vehicle, etc., which is provided with a lid that covers a recess region of the vehicle and has an open state and a closed state. For the sake of simplicity, the refueling port/charging port of a vehicle will be introduced below as an application scenario.

An object of the present disclosure is to at least partially solve the technical problem mentioned above. According to a first aspect, the present disclosure provides a driving assembly, including a fixed gear, a fixed rack, a movable intermediate rack, a movable gear, and a transmission rack, wherein the fixed gear is provided with a fixed rotary shaft, and the fixed gear is rotatable about the fixed rotary shaft; the position of the fixed rack remains fixed relative to the fixed rotary shaft; the movable intermediate rack is configured to cooperate with the fixed gear such that the movable intermediate rack is capable of being driven to reciprocate when the fixed gear rotates clockwise and counterclockwise; the movable gear is provided with a movable rotary shaft, wherein the movable rotary shaft is rotatably fixed to the movable intermediate rack, and wherein the movable gear cooperates with the fixed rack, and the movable gear is configured such that the movable gear is capable of reciprocatingly translating along an extension direction of the fixed rack when the movable intermediate rack reciprocates, and the movable gear is capable of rotating about the movable rotary shaft; and the transmission rack is configured to be capable of driving a member to be driven, wherein the transmission rack is configured to cooperate with the movable gear such that the transmission rack is capable of being driven to reciprocate so as to move the member to be driven when the movable gear rotates clockwise and counterclockwise.

According to the first aspect of the present disclosure, the member to be driven is provided with a housing, and the fixed rotary shaft and the fixed rack are provided on the housing of the member to be driven.

According to the first aspect of the present disclosure, the housing is provided with a driving guide portion, wherein the driving guide portion extends in a first direction, and the transmission rack is capable of reciprocating along the driving guide portion in the first direction.

According to the first aspect of the present disclosure, the movable rotary shaft is rotatably fixed to one end of the movable intermediate rack; the transmission rack is provided with a movement starting position of the transmission rack and a movement ending position of the transmission rack; in the movement starting position of the transmission rack, the movable gear cooperates with the end of the transmission rack away from the member to be driven, and the fixed gear cooperates with the end of the movable intermediate rack away from the member to be driven; and in the movement ending position of the transmission rack, the movable gear cooperates with the end of the transmission rack close to the member to be driven, and the fixed gear cooperates with the end of the movable intermediate rack close to the member to be driven.

According to the first aspect of the present disclosure, the driving assembly further includes a guide rod, a first end of the guide rod being connected to the transmission rack, and a second end of the guide rod being capable of passing through the driving guide portion and being connected to the member to be driven, such that the guide rod is capable of driving the member to be driven to reciprocate along the driving guide portion.

According to the first aspect of the present disclosure, the driving assembly further includes an actuator configured to drive the fixed gear to rotate.

According to the first aspect of the present disclosure, the member to be driven is a lid of a lid assembly of a charging port or a refueling port of a vehicle, and the transmission rack is configured to be capable of driving the lid to reciprocate.

According to the first aspect of the present disclosure, the lid assembly includes:

the housing, the lid, and a driving connection assembly, wherein the housing has a accommodating space and a door panel opening; the lid is movable relative to the housing and provided with a closed position and an open position, wherein the lid closes the door panel opening, and the transmission rack is located at the movement starting position of the transmission rack when the lid is in the closed position; and the lid is received in the accommodating space and exposes the door panel opening, and the transmission rack is located at the movement ending position of the transmission rack when the lid is located at the open position; and a first end of the driving connection assembly is connectable to the transmission rack via the guide rod so as to be capable of reciprocating linearly in the first direction, and a second end of the driving connection assembly is rotatably connected to a first end of the lid; wherein the housing further defines a first guide portion and a second guide portion, the first end of the lid is movable along the first guide portion, and a second end of the lid is movable along the second guide portion.

According to the first aspect of the present disclosure, the lid assembly is configured such that the first end of the lid firstly exits the door panel opening, and then the second end of the lid exits the door panel opening during a movement of the lid from the closed position to the open position.

According to the first aspect of the present disclosure, the first guide portion includes a first segment of the first guide portion and a second segment of the first guide portion in communication with the first segment of the first guide portion, and the second segment of the first guide portion is the driving guide portion; wherein the first segment of the first guide portion is arranged in a second direction different from the first direction.

According to a second aspect, the present disclosure provides a driving assembly, including a fixed gear, a fixed rack, a movable intermediate rack, a movable gear, and a transmission rack, wherein the fixed gear is provided with a fixed rotary shaft, and the fixed gear is rotatable about the fixed rotary shaft; the position of the fixed rack remains fixed relative to the fixed rotary shaft; the movable intermediate rack is configured to cooperate with the fixed gear such that the movable intermediate rack is capable of reciprocating when the fixed gear rotates clockwise and counterclockwise; the movable gear is provided with a movable rotary shaft, wherein the movable rotary shaft is rotatably fixed to one end of the movable intermediate rack, and wherein the movable gear cooperates with the fixed rack such that the movable gear is capable of reciprocatingly translating in an extension direction of the fixed rack when the movable intermediate rack reciprocates, and the movable gear is configured to be rotatable about the movable rotary shaft when reciprocatingly translating; and the transmission rack is configured to be capable of driving the member to be driven to reciprocate, wherein the transmission rack cooperates with the movable gear such that the transmission rack is capable of reciprocating when the movable gear rotates clockwise and counterclockwise; wherein the fixed rotary shaft and the fixed rack are arranged on the housing of the member to be driven, and the housing is provided with a driving guide portion, wherein the driving guide portion extends in the first direction, and the transmission rack is capable of reciprocating along the driving guide portion in the first direction.

According to the second aspect of the present disclosure, the driving assembly further includes: a guide rod, a first end of the guide rod being connected to the transmission rack, and a second end of the guide rod being capable of passing through the driving guide portion and being connected to the member to be driven, such that the guide rod is capable of reciprocating along the driving guide portion.

According to the second aspect of the present disclosure, the transmission rack is provided with a movement starting position of the transmission rack and a movement ending position of the transmission rack, wherein in the movement starting position of the transmission rack, the movable gear cooperates with the end of the transmission rack away from the member to be driven, and the fixed gear cooperates with the end of the movable intermediate rack away from the member to be driven; and in the movement ending position of the transmission rack, the movable gear cooperates with the end of the transmission rack close to the member to be driven, and the fixed gear cooperates with the end of the movable intermediate rack close to the member to be driven.

According to the second aspect of the present disclosure, the driving assembly further includes an actuator configured to drive the fixed gear to rotate.

According to the second aspect of the present disclosure, the member to be driven is a lid of a lid assembly of a charging port or a refueling port of a vehicle, and the transmission rack is configured to be capable of driving the lid to reciprocate.

According to a third aspect, the present disclosure provides a vehicle, including a driving assembly for driving a lid assembly according to the first aspect and the second aspect of the present disclosure.

In the driving assembly of the present disclosure, comparing the prior art, a fixed rack, an intermediate rack and a movable gear are additionally provided, so that the rack connected to the lid has a smaller size and moves at a faster speed for the same movement distance, which reduces the risk of the lid assembly interfering with other ambient components of a vehicle body and increases the opening or closing speed of the lid.

The concept, specific structures and resulting technical effects of the present disclosure will be further described below with reference to the accompanying drawings so as to fully understand the objective, features and effects of the present disclosure.

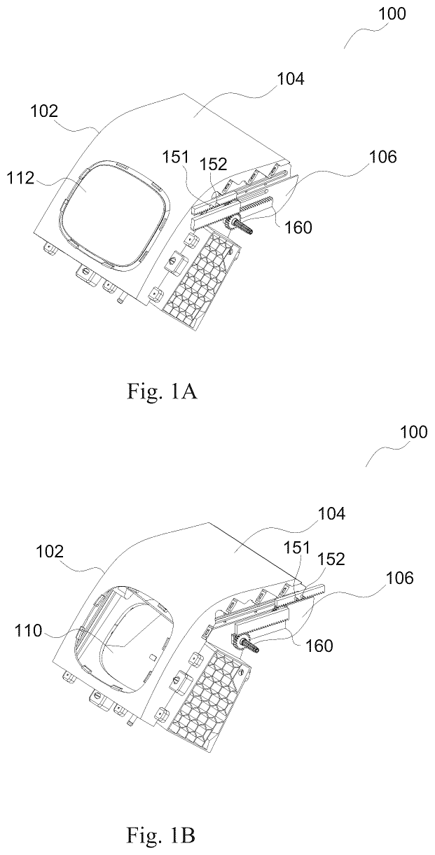

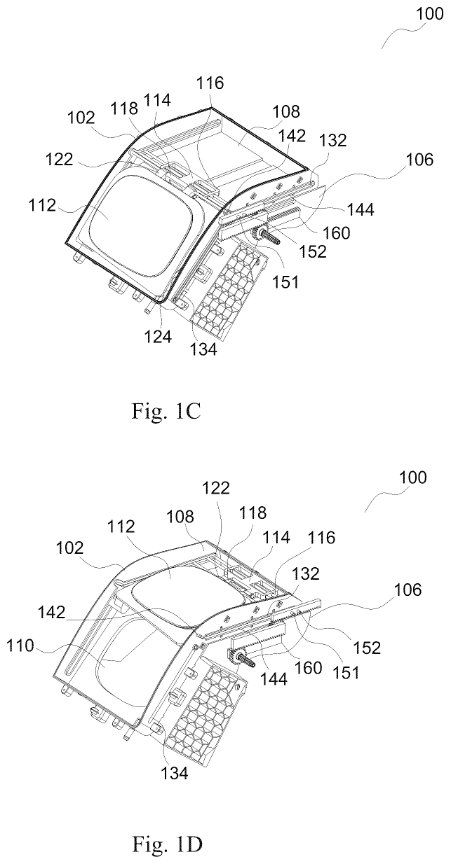

FIGS. 1A to 1D respectively show perspective views of a driving assembly 160 according to the present disclosure for driving a lid assembly 100 in a lid-open state and in a lid-closed state, with the upper cover 104 being illustrated or hidden.

As shown in FIGS. 1A to 1D, the lid assembly 100 includes a housing 102, an upper housing cover 104, and a lid 112. The housing 102 has a accommodating space 108 and a door panel opening 110. The lid 112 can move relative to the housing 102, and is provided with a closed position and an open position. When the lid 112 is in the closed position, the lid 112 closes the door panel opening 110; and when the lid 112 is in the open position, the lid 112 is accommodated in the accommodating space 108 and exposes the door panel opening 110, as shown in FIG. 1D.

Compared with FIGS. 1A and 1B, the upper housing cover 104 is hidden in FIGS. 1C and 1D to show more components in the housing 102. As shown in Figures IC and 1D, the lid 112 further includes a first end 122 of the lid and a second end 124 of the lid, the housing 102 defines a first guide portion 132 and a second guide portion 134, the first end 122 of the lid is movable along the first guide portion 132, and the second end 124 of the lid is movable along the second guide portion 134. The first end 122 of the lid 112 exits the door panel opening 110 first, and then the second end 124 of the lid 112 exits the door panel opening 110 during a movement of the lid 112 from the closed position to the open position. The first guide portion 132 defined by the housing 102 includes a first segment 142 of the first guide portion and a second segment 144 of the first guide portion which are in communication with each other, the second segment 144 of the first guide portion extending in a first direction, the first segment 142 of the first guide portion extending in a second direction, and the second guide portion 134 extending in a third direction.

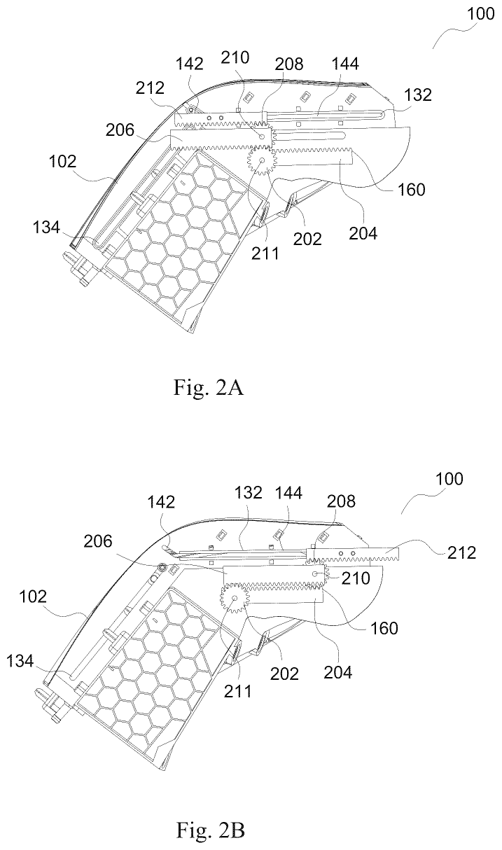

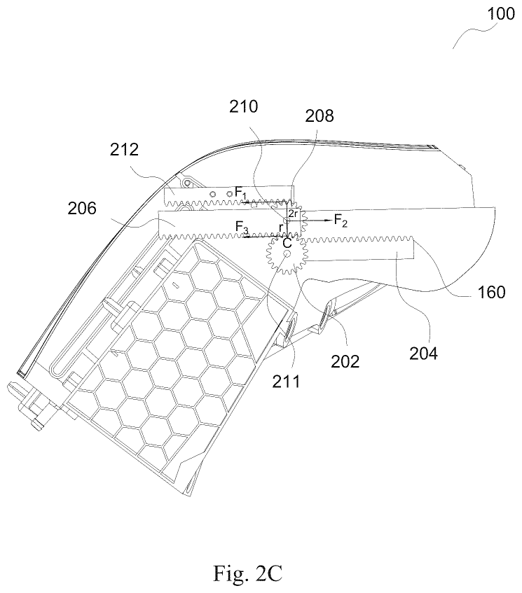

With continued reference to Figures IC and 1D, the lid assembly 100 further includes a driving connection assembly 114 which is provided with a first end 116 of the driving connection assembly and a second end 118 of the driving connection assembly hinged with each other. The driving assembly 160 includes two guide rods 151, 152, and the first end 116 of the driving connection assembly can be connected to a transmission rack 212 (sec FIGS. 2A and 2B) of the driving assembly 160 by means of the two guide rods 151, 152. Specifically, first ends of the guide rods 151, 152 are connected to the transmission rack 212, and second ends of the guide rods 151, 152 can pass through the second part 144 of the first guide portion and be connected to the first end 116 of the driving connection assembly, such that the guide rods 151, 152 can drive the first end 116 of the driving connection assembly to reciprocate linearly along the second segment 144 of the first guide portion. Since the two guide rods 151, 152 are limited to move in the second segment 144 of the first guide portion, the first end 116 of the driving connection assembly can reciprocate linearly in the first direction. It should be noted that although two guide rods are provided in the present disclosure, those skilled in the art can understand that one rod or more than two guide rods can be provided and connected to the driving connection assembly 114 in other examples.

The second end 118 of the driving connection assembly is rotatably hinged with the first end 122 of the lid 112, such that the lid 112 can be driven to move during the movement of the guide rods 151, 152 along the second segment 144 of the first guide portion to enable the lid 112 to move between the closed position and the open position. Since the transmission rack 212 passes through the second section 144 of the first guide portion and is connected to the first end 116 of the driving connection assembly by means of the guide rods 151, 152, the transmission rack 212 is also limited to reciprocate linearly along the second segment 144 of the first guide portion (i.e., in the first direction).

Thus, the reciprocating linear movement of the transmission rack 212 in the first direction can be converted finally into the movement of the lid 112 between the closed position shown in FIGS. 1A and 1C and the open position shown in FIGS. 1B and 1D by means of the guide rods 151, 152, the first end 116 of the driving connection assembly, the second end 118 of the driving connection assembly, and the first end 122 of the lid.

FIGS. 2A and 2B are side views of the lid assembly 100 shown in FIGS. 1A and 1B with the lid 112 being in the closed position and in the open position to illustrate more details of the driving assembly 160.

As shown in FIGS. 2A and 2B, the driving assembly 160 includes a fixed gear 202, a fixed rack 204, a movable intermediate rack 206, a movable gear 208, the transmission rack 212, and the actuator (not shown). The fixed gear 202 is provided with a fixed rotary shaft 211 arranged on the housing 102, such that the fixed gear 202 is rotatable about the fixed rotary shaft 211. The actuator is arranged in the accommodating space 108 of the housing 102 and is configured to drive the fixed gear 202 to rotate. Preferably, the actuator is configured to be arranged coaxially with the fixed rotary shaft 211 of the fixed gear 202. However, those skilled in the art can understand that the actuator can also drive the fixed gear 202 to rotate by means of the cooperation between an intermediate transmission component and the fixed gear 202.

The fixed rack 204 is fixedly arranged on the housing 102, and thus remains the position unchanged relative to the fixed rotary shaft 211 of the fixed gear 202. In the example shown in FIGS. 2A and 2B, the fixed rotary shaft 211 of the fixed gear 202 is arranged at the left end of the fixed rack 204. However, those skilled in the art can understand that the fixed rotary shaft 211 of the fixed gear 202 can also be arranged at other positions, such as the middle, of the fixed rack 204 as long as the length of the fixed rack 204 is enough to meet the requirements of a moving stroke of the lid 112.

The movable intermediate rack 206 and the fixed gear 202 mesh with each other, such that the movable intermediate rack 206 can be driven to reciprocate when the fixed gear 202 rotates clockwise and counterclockwise. The movable gear 208 is provided with a movable rotary shaft 210 fixed to the right end of the movable intermediate rack 206. The movable gear 208 and the fixed rack 204 mesh with each other, such that the movable gear 208 can reciprocatingly translate in the extension direction of the fixed rack 204 along with the reciprocating motion of the movable intermediate rack 206 when the movable intermediate rack 206 reciprocates, and the movable gear 208 can rotate about the movable rotary shaft 210 due to the meshing thereof with the fixed rack 204 when the movable gear 208 reciprocatingly translates.

The transmission rack 212 and the movable gear 208 mesh with each other, such that the rotation of the movable gear 208 clockwise and counterclockwise about the movable rotary shaft 210 can drive the transmission rack 212 to reciprocate and in turn drive the lid 112 to move. The transmission rack 212 is provided with a movement starting position of the transmission rack (the position shown in FIG. 2A) and a movement ending position of the transmission rack (the position shown in FIG. 2B). In the movement starting position of the transmission rack, the movable gear 208 meshes with the end (the right end) of the transmission rack 212 away from the lid 112, and the fixed gear 202 meshes with the end (the right end) of the movable intermediate rack 206 away from the lid 112; and in the movement ending position of the transmission rack, the movable gear 208 meshes with the end (the left end) of the transmission rack 212 close to the lid 112, and the fixed gear 202 meshes with the end (the left end) of the movable intermediate rack 206 close to the lid 112.

Those skilled in the art can understand that the meshing between the fixed gear 202 and the movable intermediate rack 206, the meshing between the movable gear 208 and the fixed rack 204, and the meshing between the movable gear 208 and the transmission rack 212 described above are all the meshing by means of the outer circumferential teeth of the fixed gear 202 and the movable gear 208 and the teeth of the movable intermediate rack 206, the fixed rack 204 and the transmission rack 212, by means of which the rotation of the gears is converted into the translation (or movement) of the rack. Therefore, the linear speed of outer circumferential rotation of each gear is equal to the translation speed of the rack meshing with the gear.

Compared with the cooperation of gear and rack in a single set in the prior art, the above configuration of the fixed gear 202, the fixed rack 204, the movable intermediate rack 206, the movable gear 208 and the transmission rack 212 in the present disclosure allows the transmission rack 212 connected to the lid 112 to have a smaller length and move at a faster speed than the transmission rack in the prior art, thereby greatly reducing the risk of the transmission rack 212 interfering with other ambient components of the vehicle body and increasing the opening or closing speed of the lid 112.

Specifically, in terms of the size, assuming that the distance of the transmission rack moving from the movement starting position to the movement ending position is L in the prior art (for example, the movement distance L is 158 mm in the example of the present disclosure), the length of the toothed portion of the transmission rack in the prior art is at least L.

In the present disclosure, as shown in FIGS. 2A and 2B, the movable intermediate rack 206 is additionally provided to play a role of displacement compensation for the transmission rack 212, that is, the displacement of the transmission rack 212 relative to the fixed gear 202 (the main driving gear) is sum of the displacement of the transmission rack 212 relative to the movable gear 208 and the displacement of the movable gear 208 relative to the fixed gear 202 (the main driving gear). Assuming that the tooth length of the movable intermediate rack 206 and the tooth length of the transmission rack 212 are L1 and L2, respectively, and the distance of the transmission rack 212 moving from the movement starting position to the movement ending position is L, then L=L1+L2. In a preferred example, the length of the movable intermediate rack 206 is equal to the length of the transmission rack 212, that is: L1=L2=L/2.

It can be seen that in order to allow the lid 112 to reach the same movement range (i.e., the movement of the lid 112 from the closed position to the open position), the length of the toothed portion of the transmission rack 212 connected to the lid 112 in the present disclosure is half of the length of the toothed portion of the transmission rack in the prior art, which can greatly reduce the risk of the transmission rack interfering with other ambient components of the vehicle body.

In terms of the movement speed of the rack, in the prior art, assuming that the outer circumferential rotation speed of the main driving gear is V1, the translation speed of the transmission rack meshing with the main driving gear is equal to the outer circumferential rotation speed of the main driving gear, that is, V1. Therefore, the movement speed of the end of the lid connected to the transmission rack is also V1.

In the present disclosure, as shown in FIGS. 2A and 2B, in a preferred example, assuming that these gears and the racks are equal in terms of the number of teeth, the pitch and dimension; if the outer circumferential rotation speed of the fixed gear 202 (the main driving gear) is V2, the translation speed of the movable intermediate rack 206 relative to the fixed gear 202 is V2, and the translation speed of the movable gear 208 fixed at the right end of the movable intermediate rack 206 relative to the fixed gear 202 is also V2. Since the movable intermediate rack 206 and the fixed rack 204 are equal in terms of the number of teeth and the pitch, the fixed gear 202 and the movable gear 208 have the same gear parameters. During the meshing transmission of the movable gear 208 and the fixed rack 204, the translation speed of the fixed rack 204 relative to the movable gear 208 (actually the translation of the movable gear 208 relative to the fixed rack 204) is equal to the translation speed V2 of the movable intermediate rack 206 relative to the fixed gear 202, and at the same translation speed, the outer circumferential rotation speed of the movable gear 208 should also be equal to the outer circumferential rotation speed V2 of the fixed gear 202. Since the transmission rack 212 is in meshing transmission with the movable gear 208, the translation speed of the transmission rack 212 relative to the movable gear 208 is equal to the outer circumferential rotation speed of the movable gear 208, that is, the translation speed of the transmission rack 212 relative to the movable gear 208 is also equal to V2. It can be calculated that the translation speed Vo of the transmission rack 212 relative to the fixed gear 202 is the sum of the translation speed of the movable gear 208 relative to the fixed gear 202 and the translation speed of the transmission rack 212 relative to the movable gear 208, that is:

$${V}_{0} = {V}_{2} + {V}_{2} = 2 {V}_{2} .$$

Therefore, the movement speed of the end of the lid 112 connected to the transmission rack 212 is twice the outer circumferential rotation speed of the fixed gear 202 (the main driving gear).

In the above example of the present disclosure, when an input voltage is 13.5 V, the relationship between the rotational speed n of an output shaft of the actuator and a load T of the actuator is fitted on the basis of test data as follows:

$$n = - 3.4 \times T + 32.4 ,$$

where n represents the rotational speed of the output shaft of the actuator in rpm; and T represents the load of the actuator in N·m, the coefficient of T−3.4 is in rpm/N·m, and the constant 32.4 is in rpm.

In the example of the present disclosure, the input voltage is 13.5 V which is constant; the mass of the lid 112 is 0.33 kg, that is, the weight of the lid 112 is 3.3 N; and the reference circle radius r of the fixed gear 202 (the main driving gear) is 13.3 mm, that is, 1.33×10⁻² m. If the masses and frictional forces of the gears and racks in the driving assembly 160 are negligible and the angle of inclination of the lid 112 is also negligible, the resistance exerted by the lid 112 to the transmission rack 212 may be approximately equal to the gravity of the lid 112, that is, 3.3 N.

In the case of the cooperation of gear and rack in a single set (i.e., the technical solution in the prior art), a load T₁ of an actuator motor is a torque applied by the transmission rack to the main driving gear, and the calculation formula is as follows:

$${T}_{1} = 3.3 N \times 1.33 \times {10}^{- 2} m = 0.044 N \cdot m ,$$

the calculation formula for the rotational speed n₁ of the actuator corresponding to the above torque T₁ is as follows:

$${n}_{1} = - 3.4 \times {T}_{1} + 32.4 = 32.25 ( rpm ) ,$$

and
if the actuator is coaxially connected to the main driving gear, the rotational speed of the main driving gear is equal to n₁, that is, 32.25 rpm.

Assuming that the outer circumferential radius of the main driving gear is approximately equal to the index circle radius r of the toothed portion thereof, the calculation formula for the outer circumferential rotation speed V₁ of the main driving gear is as follows:

$${V}_{1} = {n}_{1} \times 2 π r = 2.69 ( m / min ) = 449 ( cm / s ) ,$$

the movement speed of the end of the lid connected to the transmission rack is also V₁, that is, 4.49 cm/s.

FIG. 2C is a schematic diagram illustrating force analysis of the driving assembly 160 of the present disclosure.

As shown in FIG. 2C, in the present disclosure, assuming that the movable intermediate rack 206 exerts a rightward acting force F₂ to the movable gear 208 at the center of rotation of the movable gear 208, and the transmission rack 212 exerts a leftward acting force F₁ to the movable gear 208 on the upper peripheral side of the movable gear 208, the acting force F₁ is approximately equal to the gravity 3.3 N of the lid 112. Since the movement trajectory of the movable gear 208 is overlapping of the translation and the rotation, the pivot C of rotation is on the lower peripheral side of the movable gear 208. Based on the lever principle, it can be seen that F₁×2r =F₂×r (where r represents the outer circumferential radius of the movable gear 208), and therefore F₂=2F₁ =6.6 N.

Since the movable intermediate rack 206 only translates, the counter-acting force exerted by the movable gear 208 to the movable intermediate rack 206 is also F₂. Based on the force balance principle, the acting force F₃ exerted by the fixed gear 202 to the movable intermediate rack 206 should be equal to F₂, that is, 6.6 N.

At this time, the load T₂ of the actuator motor is the torque applied by the transmission rack to the fixed gear 202 (the main driving gear), and the calculation formula is as follows:

$${T}_{2} = 6.6 N \times 1.33 \times {10}^{- 2} m = 0.088 N \cdot m ,$$

the calculation formula for the rotational speed n2 of the actuator corresponding to the above torque T₂ is as follows:

$$n 2 = - 3.4 \times {T}_{1} + 32.4 = 32.1 ( rpm ) ,$$

if the actuator is coaxially connected to the fixed gear 202 (the main driving gear), the rotational speed of the fixed gear 202 (the main driving gear) is equal to n2, that is, 32.10 rpm.

Assuming that the outer circumferential radius of the fixed gear 202 (the main driving gear) is approximately equal to the index circle radius r of the toothed portion thereof, the calculation formula for the outer circumferential rotation speed V2 of the fixed gear 202 (the main driving gear) is as follows:

V2=n2×2πr=5.36 (m/min)=8.94 (cm/s).

When the input voltage is 13.5 V, the rotational speeds of the actuator motor under the loads T₁ and T₂ are 32.25 rpm and 32.10 rpm, respectively. It can be seen that the change in load has little effect on the rotational speed of the actuator motor within a small load range, for example, in a range less than or equal to 0.1 N.m. Therefore, the gear and rack structure of the driving assembly 160 of the present disclosure can increase the opening or closing speed of the lid 112 approximately twice of the opening or closing speed in the prior art.

The process of the lid 112 moving from the closed position to the open position will be described below with reference to FIGS. 1C and 1D and FIGS. 2A and 2B.

As shown in FIGS. 1C and 2A, the lid 112 is in the closed position, at this time the transmission rack 212 is in the movement starting position of the transmission rack, the movable gear 208 meshes at the right end of the transmission rack 212, and the fixed gear 202 meshes at the right end of the movable intermediate rack 206. When a driver needs to open the lid 112, the driver can drive the driving assembly 160 to enable the actuator to drive the fixed gear 202 to rotate clockwise; the clockwise rotation of the fixed gear 202 drives the movable intermediate rack 206 meshing with the fixed gear to move rightward, the rightward movement of the movable intermediate rack 206 pushes the movable gear 208 to translate rightward, and since the movable gear 208 meshes with the fixed rack 204 during the translation, the rightward translation of the movable gear 208 drive the fixed rack to rotate clockwise; and the clockwise rotation of the movable gear 208 can drive the transmission rack 212 meshing with the movable gear to move rightward, the rightward movement of the transmission rack 212 can drive the guide rods 151, 152 connected to the transmission rack to move rightward, and since the guide rods 151, 152 pass through the second section 144 of the first guide portion and are connected to the first end 116 of the driving connection assembly, the guide rods 151, 152 are limited to move in the first direction in which the second section 144 of the first guide portion extends, and thus the first end 116 of the driving connection assembly also moves rightward in the first direction. The rightward movement of the first end 116 of the driving connection assembly in the first direction can drive the second end 118 of the driving connection assembly hinged with the first end to move, and the end of the second end 118 of the driving connection assembly hinged with the first end 122 of the lid is limited to move in both the second direction in which the first section 142 of the first guide portion extends and the first direction in which the second section 144 of the first guide portion extends. The movement of the first end 122 of the lid can drive the second end 124 of the lid to rotate in the second guide portion 134 and then move in the third direction in which the second guide portion 134 extends. After the first end 122 of the lid moves to the second section 144 of the first guide portion, the lid 112 rises gradually to expose the door panel opening 110, the lid 112 is finally moved to the open position shown in FIGS. 1D and 2B, and at this time, the transmission rack 212 is located at the movement ending position of the transmission rack, the movable gear 208 meshes at the left end of the transmission rack 212, and the fixed gear 202 meshes at the left end of the movable intermediate rack 206.

When the driver needs to close the lid 112, the driver can drive the driving assembly 160 to enable the actuator to drive the fixed gear 202 to rotate counterclockwise. The rotation direction of each gear and the movement path of each rack and the lid are opposite to those of the lid 112 during the opening process, which will not be described again herein.

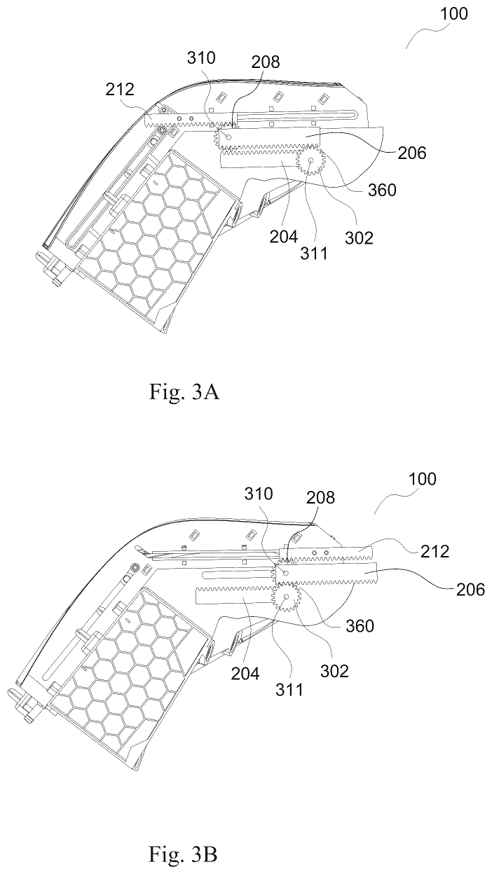

FIGS. 3A and 3B are perspective views of another example of the driving assembly 360 in a lid-closed state or in a lid-open state.

Since the driving assembly 360 of the example shown in FIGS. 3A and 3B is structurally similar to the driving assembly 160 of the example shown in FIGS. 2A and 2B, the components having the same structures will not be described again herein. The structural difference lies that in FIGS. 3A and 3B the fixed rotary shaft 311 of the fixed gear 302 is arranged at the right end of the fixed rack 204, and the movable rotary shaft 310 of the movable gear 208 is arranged at the left end of the movable intermediate rack 206. Similar to FIGS. 2A and 2B, the transmission rack 212 is provided with a movement starting position of the transmission rack (the position shown in FIG. 3A) and a movement ending position of the transmission rack (the position shown in FIG. 3B). In the movement starting position of the transmission rack, the movable gear 208 meshes with the right end of the transmission rack 212, and the fixed gear 302 meshes with the right end of the movable intermediate rack 206; and in the movement ending position of the transmission rack, the movable gear 208 meshes with the left end of the transmission rack 212, and the fixed gear 302 meshes with the left end of the movable intermediate rack 206.

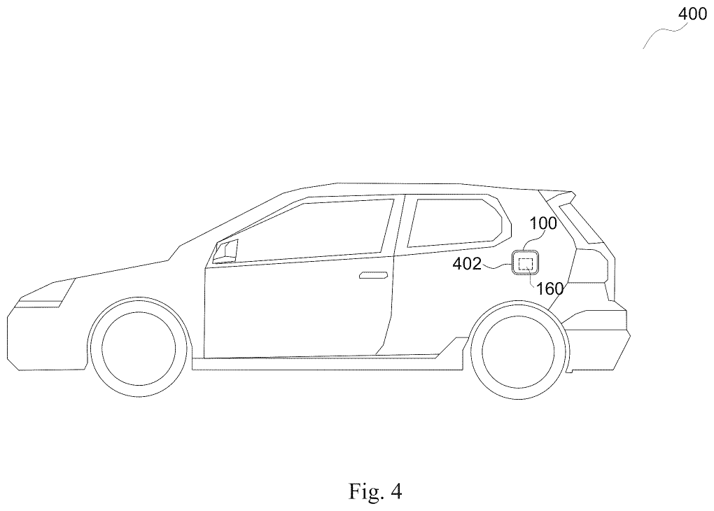

FIG. 4 is a schematic diagram of a vehicle 400 provided with the lid assembly 100 and the driving assembly 160 of the present disclosure, which illustrates an application scenario of the lid assembly 100 and the driving assembly 160 of the present disclosure.

As shown in FIG. 4, the vehicle 400 has a refueling port 402, the lid assembly 100 can be configured to cover the refueling port 402, and the lid in the lid assembly 100 is driven by the driving assembly 160 to move. The lid assembly 100 and the driving assembly 160 in FIG. 4 are merely exemplary. The lid assembly 100 of the present disclosure can also be applied to any scenario, for example, a charging port of an electric vehicle, a door handle of a vehicle, or a liquid filling port of a vehicle, which covers the recess region of the vehicle and has the open state and the closed state.

Compared with the driving assembly in the prior art, the driving assembly of the present disclosure has the advantages as follows:

First, according to the examples of the present disclosure, a movable gear, a fixed rack and an intermediate rack are additionally provided on the basis of the prior art, which reduces the length of the transmission rack connected to the lid, such that the length of the transmission rack extending rightward is shorter in the present disclosure than in the prior art when the lid is moved from the closed position to the open position, thereby reducing the risk of the lid assembly interfering with other ambient components of the vehicle body.

Second, the movement speed of the transmission rack in the present disclosure is increased to twice the movement speed of the transmission rack in the prior art, which shortens the lid opening or closing time.

Third, the gear transmission structure of the driving assembly of the present disclosure can achieve the same lid opening or closing time as the prior art at a lower input voltage.

Although the present disclosure is described with reference to the examples of examples outlined above, various alternatives, modifications, variations, improvements and/or substantial equivalents, which are known or anticipated at present or to be anticipated before long, may be obvious to those of at least ordinary skill in the art. In additional, the technical effects and/or technical problems described in this specification are exemplary rather than limiting. Therefore, the disclosure in this specification may be used to solve other technical problems and have other technical effects and/or may solve other technical problems. Accordingly, the examples of the examples of the present disclosure as set forth above are intended to be illustrative rather than limiting. Various changes may be made without departing from the spirit or scope of the present disclosure. Therefore, the present disclosure is intended to embrace all known or earlier disclosed alternatives, modifications, variations, improvements and/or substantial equivalents.

What is claimed is:

1. A driving assembly, comprising:
a fixed gear provided with a fixed rotary shaft, and the fixed gear being rotatable about the fixed rotary shaft;
a fixed rack, a position of the fixed rack remaining fixed relative to the fixed rotary shaft;
a movable intermediate rack configured to cooperate with the fixed gear such that the movable intermediate rack is capable of being driven to reciprocate when the fixed gear rotates clockwise and counterclockwise;
a movable gear provided with a movable rotary shaft, wherein the movable rotary shaft is rotatably fixed to the movable intermediate rack, and wherein the movable gear cooperates with the fixed rack, and the movable gear is configured such that the movable gear is capable of reciprocatingly translating along an extension direction of the fixed rack when the movable intermediate rack reciprocates, and the movable gear is capable of rotating about the movable rotary shaft; and
a transmission rack configured to be capable of driving a member to be driven, wherein the transmission rack is configured to cooperate with the movable gear such that the transmission rack is capable of being driven to reciprocate so as to move the member to be driven when the movable gear rotates clockwise and counterclockwise.

2. The driving assembly according to claim 1, wherein the member to be driven is provided with a housing, and the fixed rotary shaft and the fixed rack are provided on the housing of the member to be driven.

3. The driving assembly according to claim 2, wherein the housing is provided with a driving guide portion, and wherein the driving guide portion extends in a first direction, and the transmission rack is capable of reciprocating along the driving guide portion in the first direction.

4. The driving assembly according to claim 3, wherein:
the movable rotary shaft is rotatably fixed to one end of the movable intermediate rack;
the transmission rack is provided with a movement starting position of the transmission rack and a movement ending position of the transmission rack;
in the movement starting position of the transmission rack, the movable gear cooperates with the end of the transmission rack away from the member to be driven, and the fixed gear cooperates with the end of the movable intermediate rack away from the member to be driven; and
in the movement ending position of the transmission rack, the movable gear cooperates with the end of the transmission rack close to the member to be driven, and the fixed gear cooperates with the end of the movable intermediate rack close to the member to be driven.

5. The driving assembly according to claim 3, further comprising a guide rod, a first end of the guide rod being connected to the transmission rack, and a second end of the guide rod being capable of passing through the driving guide portion and being connected to the member to be driven, such that the guide rod is capable of driving the member to be driven to reciprocate along the driving guide portion.

6. The driving assembly according to claim 1, further comprising an actuator configured to drive the fixed gear to rotate.

7. The driving assembly according to claim 4, wherein the member to be driven is a lid of a lid assembly of a charging port or a refueling port of a vehicle, and the transmission rack is configured to be capable of driving the lid to reciprocate.

8. The driving assembly according to claim 7, wherein:
the lid assembly comprises:
the housing having a accommodating space and a door panel opening;
the lid being movable relative to the housing and provided with a closed position and an open position, wherein the lid closes the door panel opening, and the transmission rack is located at the movement starting position of the transmission rack when the lid is located at the closed position; and the lid is received in the accommodating space and exposes the door panel opening, and the transmission rack is located at the movement ending position of the transmission rack when the lid is located at the open position; and
a driving connection assembly, a first end of the driving connection assembly being connectable to the transmission rack via the guide rod so as to be capable of reciprocating linearly in the first direction, and a second end of the driving connection assembly being rotatably connected to a first end of the lid;
wherein the housing further defines a first guide portion and a second guide portion, the first end of the lid is movable along the first guide portion, and a second end of the lid is movable along the second guide portion.

9. The driving assembly according to claim 8, wherein the lid assembly is configured such that the first end of the lid firstly exits the door panel opening, and then the second end of the lid exits the door panel opening during a movement of the lid from the closed position to the open position.

10. The driving assembly according to claim 8,
wherein the first guide portion comprises a first section of the first guide portion and a second section of the first guide portion in communication with the first section of the first guide portion, and the second section of the first guide portion is the driving guide portion, and
wherein the first section of the first guide portion is arranged in a second direction different from the first direction.

11. A driving assembly, comprising:
a fixed gear provided with a fixed rotary shaft, and the fixed gear being rotatable about the fixed rotary shaft;
a fixed rack, the position of the fixed rack remaining fixed relative to the fixed rotary shaft;
a movable intermediate rack configured to cooperate with the fixed gear such that the movable intermediate rack is capable of reciprocating when the fixed gear rotates clockwise and counterclockwise;
a movable gear provided with a movable rotary shaft, wherein the movable rotary shaft is rotatably fixed to one end of the movable intermediate rack, and wherein the movable gear cooperates with the fixed rack such that the movable gear is capable of reciprocatingly translating in an extension direction of the fixed rack when the movable intermediate rack reciprocates, and the movable gear is configured to be rotatable about the movable rotary shaft while reciprocatingly translating; and
a transmission rack configured to be capable of driving a member to be driven to reciprocate, wherein the transmission rack cooperates with the movable gear such that the transmission rack is capable of reciprocating when the movable gear rotates clockwise and counterclockwise;
wherein the fixed rotary shaft and the fixed rack are provided on a housing of the member to be driven, and
the housing is provided with a driving guide portion, wherein the driving guide portion extends in a first direction, and the transmission rack is capable of reciprocating along the driving guide portion in the first direction.

12. The driving assembly according to claim 11, further comprising a guide rod, a first end of the guide rod being connected to the transmission rack, and a second end of the guide rod being capable of passing through the driving guide portion and being connected to the member to be driven, such that the guide rod is capable of reciprocating along the driving guide portion.

13. The driving assembly according to claim 11, wherein:
the transmission rack is provided with a movement starting position of the transmission rack and a movement ending position of the transmission rack,
in the movement starting position of the transmission rack, the movable gear cooperates with the end of the transmission rack away from the member to be driven, and the fixed gear cooperates with the end of the movable intermediate rack away from the member to be driven; and
in the movement ending position of the transmission rack, the movable gear cooperates with the end of the transmission rack close to the member to be driven, and the fixed gear cooperates with the end of the movable intermediate rack close to the member to be driven.

14. The driving assembly according to claim 11, further comprising an actuator configured to drive the fixed gear to rotate.

15. The driving assembly according to claim 11, wherein the member to be driven is a Lid assembly of a charging port or a refueling port of a vehicle, and the transmission rack is configured to be capable of driving the lid assembly to reciprocate.

16. A vehicle comprising the driving assembly of claim 1 for driving a lid assembly.
